(19) United States
(12) Patent Application Publication
(10) Pub. No.: US 2025/0078280 A1
(43) Pub. Date: Mar. 6, 2025

(54) IMAGE PROCESSING APPARATUS, IMAGE PROCESSING METHOD, AND IMAGE PROCESSING SYSTEM

(71) Applicant: CANON KABUSHIKI KAISHA, Tokyo (JP)

(72) Inventor: Shinichi UEMURA, Kanagawa (JP)

(21) Appl. No.: 18/806,745

(22) Filed: Aug. 16, 2024

(30) Foreign Application Priority Data
Aug. 30, 2023 (JP) 2023-140269

(51) Int. Cl. G06T 7/11; G06T 7/194

(52) U.S. Cl. CPC G06T 7/11; G06T 7/194

(57) ABSTRACT

An image processing apparatus detects a foreground region from an input image, obtains a plurality of divided regions by dividing the foreground region, determines a circumscribed rectangle for one of the plurality of divided regions and transmits data of the input image corresponding to the circumscribed rectangle.

### BACKGROUND

### Field

The present disclosure relates to an image processing apparatus, an image processing method, and an image processing system, and particularly to a technique for generating a virtual viewpoint image.

### Description of the Related Art

A technique currently drawing attention uses a plurality of images captured by a plurality of image capturing apparatuses to generate a virtual viewpoint image from a specified virtual viewpoint. For example, Japanese Patent Laid-Open No. 2015-45920 describes placing a plurality of cameras at different positions, and inputting videos acquired by respective cameras to a virtual viewpoint video generation apparatus. Japanese Patent Laid-Open No. 2015-45920 describes generating a virtual viewpoint image by recovering a three-dimensional shape of a physical entity based on an input video.

### SUMMARY

According to an embodiment, an image processing apparatus detects a foreground region from an input image, obtains a plurality of divided regions by dividing the foreground region, determines a circumscribed rectangle for one of the plurality of divided regions and transmits data of the input image corresponding to the circumscribed rectangle.

Further features of the present disclosure will become apparent from the following description of exemplary embodiments (with reference to the attached drawings).

### BRIEF DESCRIPTION OF THE DRAWINGS

FIG. 1 illustrates a configuration example of an image processing system according to an embodiment.

FIG. 2 illustrates a hardware configuration example of an image processing apparatus according to an embodiment.

FIGS. 3A to 3E illustrate an example of a method of calculating a circumscribed rectangle.

FIG. 4 is a flowchart of an image processing method according to an embodiment.

FIG. 5 is a flowchart of an image processing method according to an embodiment.

FIGS. 6A and 6B are a flowchart of an image processing method according to an embodiment.

FIG. 7 illustrates a configuration example of an image processing system according to an embodiment.

FIGS. 8A to 8D illustrate an example of a method of calculating a circumscribed rectangle.

FIG. 9 illustrates a configuration example of an image processing system according to an embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but limitation is not made to require all such features, and multiple such features may be combined as appropriate. Furthermore, in the attached drawings, the same reference numerals are given to the same or similar configurations, and redundant description thereof is omitted.

In order to generate a high-quality virtual viewpoint image, a large-size and high-resolution digital image is used. Accordingly, generating a high-quality virtual viewpoint image using the technique described in Japanese Patent Laid-Open No. 2015-45920 results in a higher transmission load of videos from a camera to a virtual viewpoint video generation apparatus. In particular, when the transmission load has further increased due to the large number of cameras, there is a possibility that transmission itself can no longer be performed.

An embodiment of the present disclosure can reduce the transmission load of images.

### Overview of Image Processing System

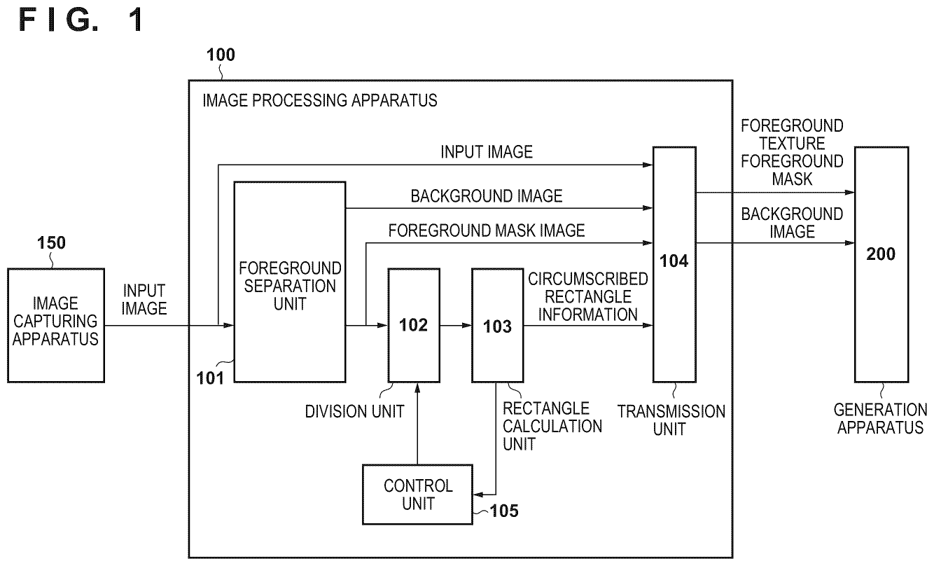

FIG. 1 illustrates a configuration example of an image processing system according to an embodiment. The image processing system illustrated in FIG. 1 can generate a virtual viewpoint image. The virtual viewpoint image generated by the image processing system is also referred to as a free viewpoint image. Generating a virtual viewpoint image allows the user to monitor an image corresponding to a freely (arbitrarily) specified viewpoint. The virtual viewpoint image may be an image corresponding to a viewpoint selected by the user from a limited number of virtual viewpoint candidates. Here, specification of the virtual viewpoint may be performed by a user operation or may be automatically performed. Automatic specification of a virtual viewpoint image can be performed based on a result of image analysis using, for example, machine learning by an Artificial Intelligence (AI) system. Here, the image processing system may generate still images, or may generate moving images. Such a moving image (virtual viewpoint video) is represented by a plurality of virtual viewpoint images.

A virtual viewpoint image is generated, for example, by a method such as follows. First, a plurality of image capturing apparatuses 150 (cameras) capture, from a plurality of directions, an image capturing region including an object. The image capturing region may be a region extending upward from a field of a stadium as high as any height, for example. In addition, the image capturing region may be any region such as a concert hall or an image capturing studio. The image capturing region may correspond to a three-dimensional space that accommodates the three-dimensional shape of the object to be estimated. The three-dimensional space may be the whole or a part of the image capturing region. The image processing system estimates the three-dimensional shape of the object located in such a three-dimensional space.

The plurality of image capturing apparatuses 150, respectively placed at different positions in a manner surrounding the image capturing region, capture images in synchronization. The plurality of image capturing apparatuses 150 may be placed to shoot from different image capturing directions (attitudes), respectively. The plurality of image capturing apparatuses 150 may be placed along the entire circumference of the image capturing region, for example. On the other hand, the region having the plurality of image capturing apparatuses 150 arranged therein may exist in a limited direction with respect to the image capturing region. When there are a limited number of placement sites, the plurality of image capturing apparatuses 150 may be arranged in the aforementioned manner. Here, the plurality of image capturing apparatuses 150 are synchronized in accordance with common time points. In addition, an image of each frame acquired by the image capturing apparatus 150 is associated with image capturing time point information.

The number of the image capturing devices 150 is not particularly limited. When, for example, the image capturing region is a rugby field, several tens to hundreds of the image capturing apparatuses 150 may be placed around the field. In addition, the plurality of image capturing apparatuses 150 may include cameras having different angles of view. For example, the image capturing apparatus 150 may include a wide-angle camera and a telephoto camera. Capturing a high-resolution image of a player using a telephoto camera allows for improving the resolution of the generated virtual viewpoint image. On the other hand, capturing an image using a wide-angle camera allows for reducing the number of cameras. In particular, when shooting a ball game, it is effective to use a wide-angle camera due to the wide range the ball travels. Furthermore, combining the image capturing regions covered by a wide-angle camera and a telephoto camera allows for improving the degree of freedom of the placement positions of the image capturing apparatuses 150.

The image processing apparatus 100 detects a foreground region from an input image. In the present example, the input image is a captured image acquired by the image capturing apparatus 150. In other words, the image capturing apparatus 150 inputs the captured image to the image processing apparatus 100. Here, the image capturing apparatus 150 may capture a moving image. In such a case, the input image is an image of a single frame of the moving image.

The foreground region is a region of an object in the input image. In the present embodiment, an object refers to a moving object (moving body) exhibiting a movement (its position or shape may change) while being captured from a same direction in time series. The object may be a person, for example. In a sports game, for example, the object may include persons such as players or umpires in the field. Additionally, in a concert or an entertainment, the object includes singers, instrumentalists, performers, MCs, or the like. Furthermore, the object may include a physical entity such as a ball. For example, the object may include a physical entity used in sports (e.g., a ball in a ball game). In addition, the image processing apparatus 100 can extract from the input image a foreground image including the foreground region.

The image processing apparatus 100 can further extract from the input image a background image in the background region. The background region is a region other than the foreground region. In addition, a background image is an image in a region that is different from at least an object appearing as a foreground. For example, a background image is acquired by removing an object appearing as a foreground from the captured image. The background region of such an input image includes a background. The term “background” refers to an image capture target that is stationary or near stationary while being captured from a same direction in time series. Such an image capture target may be, for example, a stage for performing concerts or the like, a stadium for performing sports events or the like, a structure such as a goal used in ball games, or a field.

Here, an image capture target may include physical entities or the like other than the object and the background. In addition, the foreground image and the background image have texture information (color information or the like).

A generation apparatus 200 generates a virtual viewpoint image based on the foreground image extracted by the image processing apparatus 100. In the present embodiment, the generation apparatus 200 generates, based on the foreground image, a foreground model representing the three-dimensional shape of the object and texture data used for coloring the foreground model. The generation apparatus 200 then maps the texture data to the foreground model. Furthermore, the generation apparatus 200 renders the foreground model according to the virtual viewpoint indicated by the virtual viewpoint information. A virtual viewpoint image is thus generated. Here, the generation method of the virtual viewpoint image is not limited thereto. For example, for each position in an object region on the virtual viewpoint image, a corresponding three-dimensional position on the object can be determined. The color of the foreground image corresponding to the three-dimensional position can be extracted as the color of each position in the object region.

The generation apparatus 200 can also generate texture data for coloring the background model, based on the background image. The background model can represent the three-dimensional shape of the background such as a sports field. In such a case, the generation apparatus 200 can generate the virtual viewpoint image by rendering the foreground model and the background model.

The number and arrangement of respective components of the image processing system such as, for example, the image capturing apparatus 150, the image processing apparatus 100, and the generation apparatus 200 are not particularly limited. For example, the image capturing apparatus 150, the image processing apparatus 100, and the generation apparatus 200 may be incorporated in a same housing or may be realized as physically distinct apparatuses. For example, the image capturing apparatus 150, the image processing apparatus 100, and the generation apparatus 200 may be distinct devices connected to each other via a signal path. In addition, the image processing apparatuses 100 may be provided, respectively corresponding to each of the plurality of image capturing apparatuses 150. In such a case, any of the image processing apparatuses 100 can extract a foreground image from a captured image acquired by a corresponding one of the image capturing apparatuses 150 and transmit the foreground image to the generation apparatus 200. In such a case, the image processing apparatus 100 may be included in the corresponding one of the image capturing apparatuses 150. As another example, one of the image processing apparatuses 100 may extract a foreground image from the captured images acquired by some or all of the plurality of image capturing apparatuses 150.

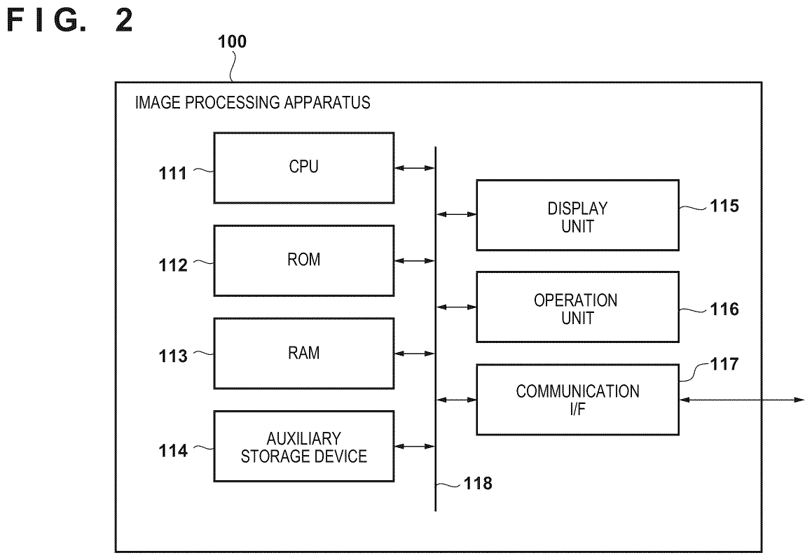

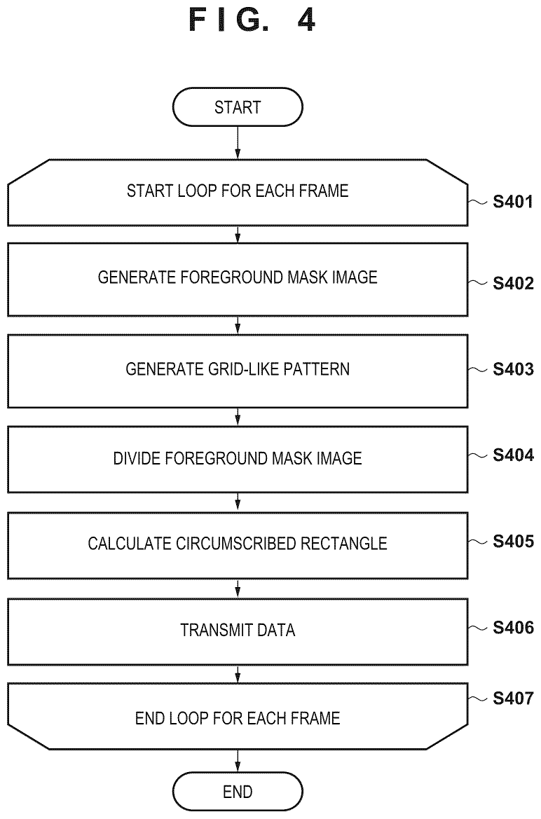

The image processing apparatus 100 may be realized by a computer including a processor and a memory. For example, a processor provided on a computer included in the image processing system can execute a program stored in a memory serving as a storage medium, as will be described below referring to FIG. 2. As such, the functions of the components illustrated in FIG. 1 or the like, and the process steps illustrated in FIG. 4 or the like can be realized. On the other hand, some or all of the functions included in the image processing apparatus 100 may be realized by hardware. The hardware may be in the form of a dedicated circuit (e.g., ASIC or FPGA), a processor (e.g., reconfigurable processor or DSP), or the like. Similarly, the functions of the image capturing apparatus 150 and the generation apparatus 200 can be realized by programs, hardware, or a combination thereof. In addition, at least one of the image capturing apparatus 150, the image processing apparatus 100, and the generation apparatus 200 may be implemented by a plurality of information processing apparatuses connected via a network, for example.

Next, a hardware configuration example of the image processing apparatus 100 will be described, referring to FIG. 2. The image processing apparatus 100 includes a CPU 111, a ROM 112, a RAM 113, an auxiliary storage device 114, a display unit 115, an operation unit 116, a communication I/F 117, and a bus 118.

The CPU 111 realizes respective functions of the image processing apparatus 100 illustrated in FIG. 1 by controlling the entire image processing apparatus 100 using computer programs or data stored in the ROM 112 or the RAM 113. The ROM 112 stores programs or the like that need not be changed. The RAM 113 temporarily stores programs or data supplied from the auxiliary storage device 114, and data or the like supplied from the outside via the communication I/F 117. The auxiliary storage device 114 stores various types of data such as image data or audio data. The auxiliary storage device 114 is a hard disk drive or the like, for example.

The display unit 115 presents to the user various types of images or information. The display unit 115 can display a Graphical User Interface (GUI) or the like to be used by the user in order to operate the image processing apparatus 100. The display unit 115 is a Liquid Crystal Display (LCD) or a Light Emitting Diode (LED). The operation unit 116 inputs various instructions to the CPU 111 in accordance with user operations. The operation unit 116 is a keyboard, a mouse, a joystick, a touch panel or the like, for example. The CPU 111 operates as a display control unit configured to control the display unit 115 and an operation control unit configured to control the operation unit 116.

The communication I/F 117 is an interface for communicating with devices external to the image processing apparatus 100. For example, when wire-connecting the image processing apparatus 100 to an external device, a communication cable is connected to the communication I/F 117. When the image processing apparatus 100 has a function of wireless communication with an external device, the communication I/F 117 has provided thereon an antenna. The bus 118 connects respective units of the image processing apparatus 100 to transmit information therebetween.

In the example of FIG. 2, the image processing apparatus 100 has the display unit 115 and the operation unit 116. However, at least one of the display unit 115 and the operation unit 116 may be provided external to the image processing apparatus 100 as a distinct device.

### First Embodiment

Referring to FIG. 1, there will be described a configuration of the image processing apparatus 100 according to an embodiment. The image processing apparatus 100 has a foreground separation unit 101, a division unit 102, a rectangle calculation unit 103, a transmission unit 104, and a control unit 105.

The foreground separation unit 101 detects a foreground region from an input image. As such, the foreground separation unit 101 separates the background region and the foreground region corresponding to a predetermined object in the input image. The method of detecting the foreground region is not particularly limited. For example, the foreground separation unit 101 can generate the background image by a sequential background updating method. Specifically, the foreground separation unit 101 can determine a foreground region to be a region in which the image exhibits a change and a background region to be a region in which the image exhibits no change during a certain time period for a plurality of input images acquired by the same image capturing apparatus 150. In addition, the foreground separation unit 101 can extract only the background region of the input image. The foreground separation unit 101 then can generate a background image using the image thus extracted. For example, the foreground separation unit 101 can generate the background image using images extracted from the background regions of each of the plurality of input images.

The foreground separation unit 101 then can detect the foreground region from the input image using the background image. For example, the foreground separation unit 101 can detect the foreground region using a background difference method. In addition, the foreground separation unit 101 can generate information indicating the detected foreground region. For example, the foreground separation unit 101 can generate a binary image (foreground mask image) indicating the foreground region. The foreground separation unit 101 may generate a foreground mask image using the input image and the background image. Specifically, the foreground separation unit 101 can generate the foreground mask image by using a predetermined threshold value to binarize the difference image acquired by subtracting the background image from the input image. In the present embodiment, a pixel value of “1” in the foreground mask image indicates that the pixel belongs to the foreground region, and a pixel value of “O” indicates that the pixel belongs to the background region. The binary values may be reversed.

Here, the method of detecting the foreground region, and the method of generating the background image and the foreground mask image are not limited to the aforementioned methods. For example, an image preliminarily captured by the image capturing apparatus 150 in the absence of any object can be stored in the frame memory. The foreground separation unit 101 can read the image and use it as a background image. Alternatively, discrimination of the foreground region and the background region may be performed using AI instead of using the background difference method. In such a case, a binary image output by AI can be used as the foreground mask image.

The division unit 102 and the rectangle calculation unit 103 calculate a circumscribed rectangle for each of a plurality of divided regions acquired by dividing a single foreground region. In the present specification, the single foreground region, which is a united foreground region represented by a group of adjacent pixels, may be referred to as a continuous foreground region. According to the method of the present embodiment, when two or more foreground regions are detected from the input image, each foreground region can be divided. For example, when three persons are included in the captured image without overlapping each other, the number of foreground regions is three assuming that a person is a foreground, which results in execution of a division process described below in each foreground region.

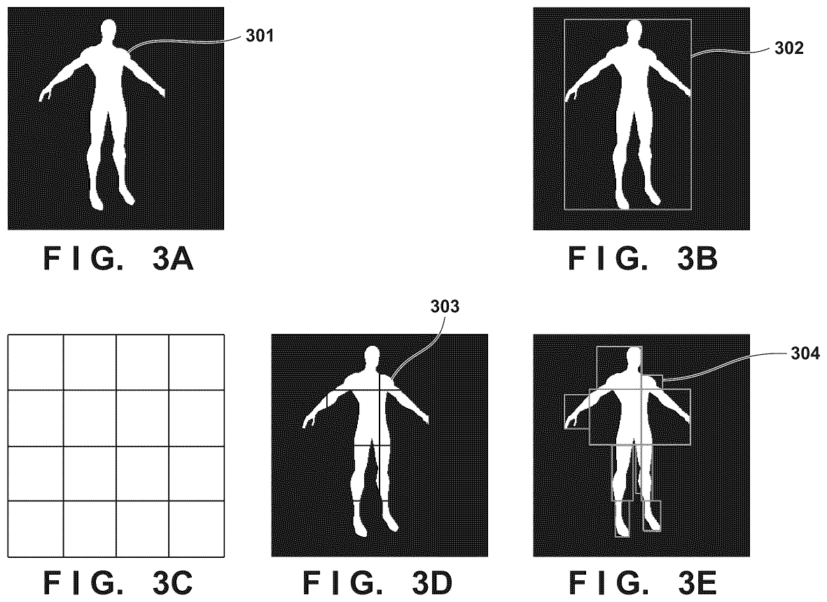

In the present embodiment, the division unit 102 divides a single foreground region by dividing the foreground mask image. The division unit 102 can divide the foreground mask image into regions of a predetermined size. The rectangle calculation unit 103 calculates a circumscribed rectangle for each of the plurality of divided regions in accordance with respective partial images of the foreground mask images acquired by division. Specifically, the rectangle calculation unit 103 can acquire a circumscribed rectangle of the foreground region in each of the divided foreground mask images. For example, the rectangle calculation unit 103 can calculate vertex coordinates of the circumscribed rectangle. As such, the rectangle calculation unit 103 can calculate a circumscribed rectangle for each of the divided regions acquired by dividing the foreground region. The processes will be described below, referring to FIGS. 3A to 3E and 4.

In the present embodiment, the plurality of divided regions are acquired by dividing the foreground region in the horizontal direction, the vertical direction, or into a grid-like pattern. To this end, the division unit 102 can divide the foreground mask image into a grid-like pattern as will be described referring to FIGS. 3C and 3D. In addition, the division unit 102 may divide the foreground mask image in the horizontal direction or the vertical direction. Additionally, in the present embodiment, the plurality of divided regions are acquired by dividing the foreground region in accordance with a predetermined spacing. For example, the division unit 102 can divide the foreground mask image in accordance with a predetermined spacing, as will be described referring to FIGS. 3C and 3D.

The transmission unit 104 transmits the data of the input image within the circumscribed rectangle to the outside. As described above, the rectangle calculation unit 103 can calculate a plurality of circumscribed rectangles. The transmission unit 104 can transmit, to the generation apparatus 200, data of partial images (referred to as foreground image representing texture) of the input image defined by respective circumscribed rectangles. In addition, the transmission unit 104 can further transmit data of the foreground mask image to the outside. Here, the transmission unit 104 can transmit data of the foreground mask image within the circumscribed rectangle to the outside similarly to the data of the input image. For example, the transmission unit 104 can transmit, to the generation apparatus 200, data of partial images of the foreground mask image defined by respective circumscribed rectangles.

As such, a transmission target in the present embodiment is limited to the information within the circumscribed rectangle. In other words, the transmission unit 104 can exclude the data of the input image and the data of the foreground mask image outside the circumscribed rectangle from transmission to the outside. As described above, the input image may be an image of a single frame of a moving image. On this occasion, the transmission unit 104 transmits, to the outside, the data of the input image within the circumscribed rectangle for each frame. On the other hand, the transmission unit 104 can exclude the data of the input image outside the circumscribed rectangle for each frame from transmission to the outside. The transmission unit 104 may further transmit background data (for example, the aforementioned background image) to the outside. Such background data may be generated from the input image. On the other hand, such background data may be common to a plurality of frames. In other words, separate background data corresponding to respective frames need not be transmitted to the outside.

Here, the transmission unit 104 may compress and then transmit the image data. When the area of the circumscribed rectangle is smaller than a threshold value, the transmission unit 104 can exclude the data of the input image within the circumscribed rectangle from transmission to the outside. In other words, when the area of a certain circumscribed rectangle is equal to or smaller than a threshold value, the transmission unit 104 need not transmit data of the input image and the foreground mask image within the circumscribed rectangle. For example, noise may be detected as a foreground region when using the background difference method. Since a foreground region detected due to having been derived from noise is usually small, the aforementioned configuration allows for determining that a small circumscribed rectangle has been derived from noise and suppressing transmission of image data within the circumscribed rectangle. It is therefore possible to reduce the amount of data transmitted from the image processing apparatus 100 to the generation apparatus 200. In addition, it is possible to suppress occurrence of artifacts that do not correspond to the object in the foreground model generated by the generation apparatus 200.

Alternatively, the transmission unit 104 may transmit image data highly-ranked in the order of area of the circumscribed rectangle and avoid transmitting image data other than those. In addition, the transmission unit 104 may specify image data up to a certain rank in the order of area of the circumscribed rectangle, compress the specified image data, and control transmission of the image data in accordance with the total data amount of compressed data. In other words, when the total amount of compressed data has exceeded a threshold value, the transmission unit 104 may avoid transmitting the image data, or may transmit the image data when the total amount of compressed data falls below the threshold value. The foregoing allows for suppressing shortage of transmission bandwidth. As such, the transmission unit 104 in an embodiment can transmit data of an input image within a circumscribed rectangle selected from a plurality of circumscribed rectangles. On this occasion, selection of a circumscribed rectangle from the plurality of circumscribed rectangles may be performed in accordance with the area of the circumscribed rectangle.

The control unit 105 can control operation of the image processing apparatus 100.

First, there will be described a process performed by the image processing apparatus 100, referring to FIGS. 3A to 3E and 4. FIG. 4 is a flowchart of process to be performed by the image processing apparatus 100 of the present embodiment. The process can be started upon the operation unit 116 receiving a user operation for starting the process.

At S401, the image processing apparatus 100 acquires an input image from the image capturing apparatus 150. At S402, the foreground separation unit 101 generates a foreground mask image as described above. FIG. 3A illustrates an example of a foreground mask image. FIG. 3A illustrates a foreground region 301.

At S403 and S404, the division unit 102 divides the foreground region. In the case of the present embodiment, the division unit 102 divides the foreground region by dividing the foreground mask image. The method of dividing the foreground region and the foreground mask image is not particularly limited. For example, the division unit 102 can divide the foreground mask image to make the size of each divided region equal to or smaller than a predetermined size. In addition, the division unit 102 can divide the foreground mask image into a grid-like pattern. In such a case, the division unit 102 can divide the foreground mask image into a grid-like pattern with a regular spacing. In the present embodiment, the foreground mask image is divided using the pattern image as described below.

At S403, the division unit 102 generates a pattern to be used for dividing the foreground mask image. The division unit 102 can generate a grid-like pattern image as illustrated in FIG. 3C, for example. The pattern image is a binary image having the same resolution as the foreground mask image. The grid is represented by one-dot-wide lines. The lines are drawn at an arbitrary or regular spacing in the horizontal and/or vertical direction. The spacing may be determined by the user operating the image processing system. In addition, the spacing may be determined in accordance with a communication speed between the image processing apparatus 100 and the generation apparatus 200. In the pattern image, the pixel values of pixels forming a line are “0”, and the pixel values of pixels other than those are “1”. However, the binary values may be reversed.

The division unit 102 can generate such a pattern image in accordance with the values of the horizontal direction counter and the vertical direction counter. The horizontal direction counter counts the value so that the maximum value corresponds to spacing of grids in the horizontal direction. In addition, the vertical direction counter counts the value so that the maximum value corresponds to the spacing of grids in the vertical direction. In the present example, the effective image region of a single-frame input image is raster-scanned. In the following, the pixel being scanned is referred to as a pixel of interest. The counters are incremented at the clock edge of the effective image region. In raster scan, for example, the horizontal direction counter is incremented in response to movement of the position of the pixel of interest in the horizontal direction, and the vertical direction counter is incremented in response to movement of the position of the pixel of interest in the vertical direction. In addition, the counters are reset when one of the following two reset conditions is satisfied. The first reset condition is that the position of the pixel of interest is located at the start position in the horizontal direction (or vertical direction) in the effective image region. The second reset condition is that the value of each counter has reached the maximum value −1 (i.e., the spacing of grids). In addition, the reset value of the counter is 0. According to the reset conditions and increment conditions, the counters repeat incrementing with a cycle from 0 to the maximum value −1 in the effective image region. Subsequently, when one or both of the counter values is 0, the pixel value of the pixel of interest is set to “0” to draw a grid line. Otherwise, the pixel value of the pixel of interest is set to “1”.

Here, the method of acquiring the pattern image is not limited to the aforementioned method. For example, the pattern image as described above may be preliminarily generated. For example, the pattern image may be stored in the frame memory. The division unit 102 can read such a pattern image.

At S404, the division unit 102 divides the foreground mask image using the pattern image acquired at S403. In the present embodiment, the division unit 102 divides the foreground mask image by calculating a logical product of pixel values of pixels located at same coordinates on both the foreground mask image and the pattern image. Formula (1) indicates a logical product operation. F (x, y) represents a pixel value of the foreground mask image. L (x, y) represents a pixel value of the pattern image. D (x, y) represents a pixel value of the foreground mask image after division. x represents X-coordinates. y represents Y-coordinates.

$$D ( x , y ) = F ( x , y ) \& L ( x , y ) \qquad Formula ( 1 )$$

FIG. 3D illustrates a result of dividing the foreground mask image illustrated in FIG. 3A in accordance with the pattern image illustrated in FIG. 3C. FIG. 3D illustrates a divided region 303 acquired by dividing the foreground region. As such, dividing the foreground mask image allows for acquiring a divided region that is the result of dividing the foreground region.

At S405, the rectangle calculation unit 103 calculates a circumscribed rectangle for each of the divided regions acquired by division. In the present embodiment, the rectangle calculation unit 103 calculates the coordinates of the circumscribed rectangle of the foreground region indicated by the divided foreground mask image acquired at S404. In the divided foreground mask image, the foreground region (region of the pixel values “1”) is divided by the line of the pixel values “0”. Therefore, using a method of determining the circumscribed rectangle for each of a plurality of regions existing in the image, it is possible to calculate the circumscribed rectangle of the foreground region in each of the divided mask images. The FIG. 3E illustrates a result of superimposing, on the foreground mask image illustrated in FIG. 3A, the circumscribed rectangle calculated from the divided foreground mask image illustrated in FIG. 3D. FIG. 3E illustrates the circumscribed rectangle 304 of the divided region. Here, the rectangle calculation unit 103 in the present embodiment performs a process of expanding, by one dot, the circumscribed rectangle of the divided region calculated in the aforementioned manner. In other words, the rectangle calculation unit 103 shifts the X-coordinates and the Y-coordinates of respective vertices of the circumscribed rectangle outward by one dot. The aforementioned process allows for filling the one-dot gap between the divided regions.

Here, an advantage of dividing the foreground region before calculating the circumscribed rectangle will be described. FIG. 3B illustrates the result of superimposing, on FIG. 3A, the circumscribed rectangle of the foreground region calculated from the foreground mask image illustrated in FIG. 3A. FIG. 3B illustrates a circumscribed rectangle 302 of an (undivided) foreground region. Comparison of the area of the circumscribed rectangle 302 illustrated in FIG. 3B with the total sum of the areas of the circumscribed rectangles 304 illustrated in FIG. 3E suggests that the latter is smaller. As such, the method of the presented embodiment reduces the amount of data transmitted at S406. In particular, the larger the proportion of the foreground occupying the angle of view, the smaller the useless region (region other than the object) in the circumscribed rectangle becomes. Accordingly, transfer load of the foreground image at S406 is further reduced.

At S406, the transmission unit 104 transmits data of the input image within the circumscribed rectangle calculated at S405 to the generation apparatus 200 as described above. The transmission unit 104 may further transmit the background image to the generation apparatus 200.

At S407, the control unit 105 determines whether or not to continue the process. For example, when the user has not performed an operation to terminate the image processing illustrated in FIG. 4 using the operation unit 116, it is determined to continue the process and returns to S401. In such a case, it is possible to calculate the circumscribed rectangle for the input image of the next frame. When, alternatively, the user has performed an operation to terminate the image processing, the image processing illustrated in FIG. 4 is terminated.

According to the present embodiment as described above, a circumscribed rectangle is calculated for each of a plurality of divided regions acquired by dividing a single foreground region. Subsequently, data of the input image within the circumscribed rectangle is transmitted to the outside. The aforementioned configuration allows for reducing the transmission load as illustrated in FIGS. 3B and 3E.

### Modification

As described above, the grid spacing used to divide the foreground region may be determined by the user. Alternatively, the grid spacing may be automatically determined. In the following modification, the control unit 105 determines the method of dividing the foreground region. For example, the plurality of divided regions may be acquired by dividing the foreground region in accordance with a predetermined spacing, as described above. Here, the control unit 105 can control the predetermined spacing. For example, the control unit 105 may determine the grid spacing (e.g., horizontal spacing and/or vertical spacing). In addition, the control unit 105 can determine the area of each rectangle included in the grid.

Specifically, the control unit 105 can control the predetermined spacing, based on the total area of the circumscribed rectangles calculated according to the predetermined spacing. In an example described below, the control unit 105 can generate a grid-like pattern image in accordance with a transmission rate of a foreground image defined below. In addition, the control unit 105 can control the predetermined spacing in accordance with the communication speed of the image processing apparatus 100. For example, the control unit 105 can generate a grid-like pattern image in accordance with the communication speed of the image processing apparatus 100.

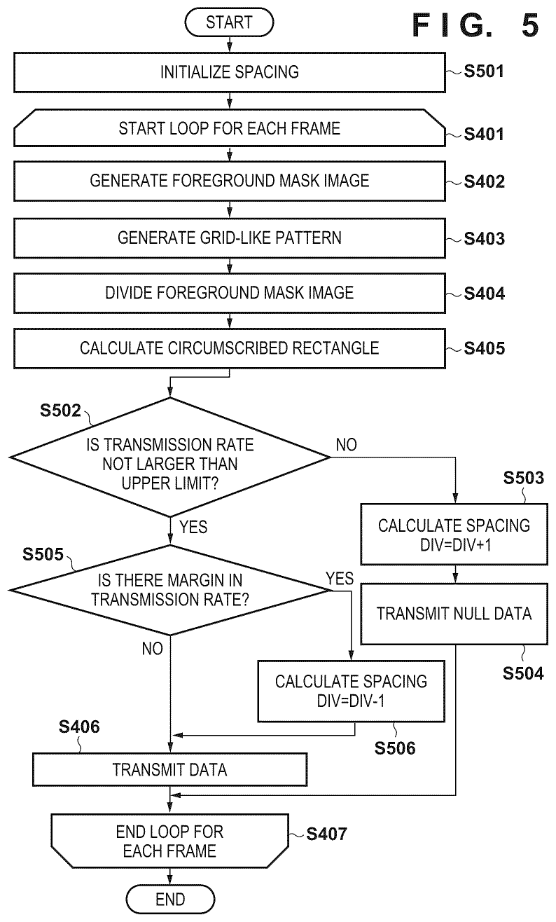

Next, a method of controlling the grid spacing will be described, referring to FIG. 5. FIG. 5 is a flowchart illustrating a process performed by the image processing apparatus 100 according to the present modification. Here, the process steps S401 to S407 are similar to those described above and description thereof will be omitted.

At S501, the control unit 105 initializes the grid spacing. For example, the control unit 105 can set the grid spacing to the same value as the resolution (i.e., the number of pixels) of the foreground mask image. Specifically, the control unit 105 can set the horizontal grid spacing (Hperiod) to the horizontal resolution (Htotal) of the foreground mask image. In addition, the control unit 105 can set the vertical grid spacing (Vperiod) to the vertical resolution (Vtotal) of the foreground mask image. Furthermore, the control unit 105 can set the number of divisions (DIV) of the grid to 1. In such a case, division of the foreground mask image is not performed. However, the initialized grid spacing is not limited to that described above. For example, the grid spacing may be initialized to allow for division.

At S502, the control unit 105 calculates the transmission rate of the foreground image. The transmission rate indicates the ratio of the total sum of the areas of the circumscribed rectangles in the foreground region relative to the area of the input image of a single frame. In the present example, the area may be represented by the number of pixels. The transmission rate can be calculated according to Formula (2). In Formula (2), T is the transmission rate. Htotal is the resolution in the horizontal direction. Vtotal is the resolution in the vertical direction. Hwidth (n) is the width of the n-th circumscribed rectangle. Vhigh (n) is the height of the n-th circumscribed rectangle. N is the total number of circumscribed rectangles in the input image of a single frame.

$$T = \frac{( {\sum }_{n = 0}^{N - 1} H w i d t h ( n ) \times V h i g h ( n ) )}{H t o l a l \times V t o t a l} \qquad ( 2 )$$

In addition, the control unit 105 compares the transmission rate thus calculated with the upper limit value of the transmission rate. The upper limit value of the transmission rate may be predetermined in the image processing system. The upper limit value of the transmission rate may be determined in accordance with the communication speed between the image processing apparatus 100 and the generation apparatus 200. For example, the upper limit value of the transmission rate may be a maximum value of the transmission rate determined so that the foreground image can be transmitted between the image processing apparatus 100 and the generation apparatus 200.

When the transmission rate is equal to or lower than the aforementioned upper limit value, the control unit 105 determines that the foreground image can be transmitted. The process then proceeds to S505. When, alternatively, the transmission rate is larger than the upper limit value, the control unit 105 determines that the foreground image cannot be transmitted. The process then proceeds to S503.

At S503, the control unit 105 updates the grid spacing so that the grid spacing becomes narrower. For example, the control unit 105 can first increment the number of divisions (DIV). The control unit 105 then can calculate the grid spacing based on Formulae (3) and (4).

$$Hperiod = Htotal / DIV \qquad Formula ( 3 )$$

$$Vperiod = Vtotal / DIV \qquad Formula ( 4 )$$

In accordance with the spacing thus updated, a grid-like pattern image to be used for dividing the foreground region of the input image of the next frame is generated. The method of calculating the grid spacing is not limited to the aforementioned method. For example, it is not necessary to use the same number of divisions (DIV) in Formulae (3) and (4). In other words, the number of divisions (DIV) used in formula (3) may be different from the number of divisions (DIV) used in formula (4). For example, the number of divisions (DIV) used in formula (3) and the number of divisions (DIV) used in formula (4) may be controlled in accordance with the ratio between the resolution in the horizontal direction (Htotal) and the resolution in the vertical direction (Vtotal) of the foreground mask image. When, for example, Htotal is about twice Vtotal, the number of divisions (DIV) used in formula (3) may be twice the number of divisions (DIV) used in formula (4). The aforementioned configuration causes the shape of the grid to be substantially square.

In addition, an upper limit may be set for the number of divisions (DIV). Such a configuration increases the number of divisions to cause the area of the circumscribed rectangle to become extremely small, and prevents the transmission unit 104 from determining that the circumscribed rectangle has been derived from noise and excluding it from transmission. In addition, such a configuration suppresses increase of transmission load due to an extreme increase in the number of circumscribed rectangles.

At S504, the transmission unit 104 transmits null data to the generation apparatus 200. Such a configuration suppresses transmission of the foreground image even though the upper limit of the transmission rate has been exceeded. Therefore, the generation apparatus 200 is prevented from performing the process based on a foreground image that has not been completely transmitted due to the limit of transfer rate.

At S505, the control unit 105 calculates a difference between the transmission rate calculated at S502 and the upper limit value of the transmission rate. The control unit 105 then compares the difference value with a margin value. The margin value may be preliminarily determined by the image processing system. When the difference value is equal to or larger than the margin value, the control unit 105 determines that there is a margin in the transmission rate, and the process proceeds to S506. When the difference value is smaller than the margin value, the control unit 105 determines that there is no margin in the transmission rate but the foreground image still can be transmitted, and the process proceeds to S406.

At S506, the control unit 105 updates the grid spacing so as to widen the grid spacing. For example, the control unit 105 can first decrement the number of divisions (DIV). The control unit 105 then can calculate the grid spacing based on the aforementioned formulae (3) and (4).

According to the modification described above, it is possible to perform a control to automatically narrow or widen the grid spacing. The transmission rate varies in accordance with the placement position and the angle of view of the image capturing apparatus 150, and the position of the object. Therefore, the optimum grid spacing is also different for each image capturing apparatus 150. The foregoing results in a large workload for the user to sequentially set the grid spacing for each of the plurality of image capturing apparatuses 150. The present modification allows for automatically determining the grid spacing for each of the plurality of image capturing apparatuses 150.

Here, the method of determining the division method of the foreground region or the foreground mask region by the control unit 105 is not limited to the method of controlling the grid spacing as described above. For example, the control unit 105 may shift the position of the grid. Specifically, the control unit 105 can control the start position of the grid. For example, the control unit 105 may control the conditions under which the division unit 102 draws the grid lines as described above. In the first embodiment, a grid line is drawn over the pixel of interest when the counter value is “0”. However, a grid line may be drawn over the pixel of interest when the counter value is a particular value other than “0”. Changing the particular value allows for controlling the starting position of the grid. For example, the particular value may be incremented in a frame-by-frame manner scrolling the grid. In addition, the particular value may be randomly determined for each frame. When the grid line is located near the edge of the foreground region, the area of the circumscribed rectangle becomes extremely small, whereby the transmission unit 104 may determine that the circumscribed rectangle has been derived from noise and exclude it from transmission. However, shifting the start position of the grid as described above prevents the image data of a part of the foreground region from being continuously excluded from transmission. As will be described in a second embodiment, when the area of a circumscribed rectangle of a divided region adjacent to another divided region is smaller than a threshold value, the rectangle calculation unit 103 may expand the circumscribed rectangle.

### Second Embodiment

In the first embodiment, the foreground mask image is divided into grid-like regions from each of which a circumscribed rectangle is calculated. However, the method of calculating the circumscribed rectangle for each of the divided regions acquired by dividing the foreground region is not limited to the aforementioned method. For example, the foreground region can be divided by any method, and a circumscribed rectangle can be calculated for each divided region. In addition, it is also possible to integrate circumscribed rectangles adjacent to each other when the areas of the circumscribed rectangles are small. Next, an example of the aforementioned method will be described in the second embodiment.

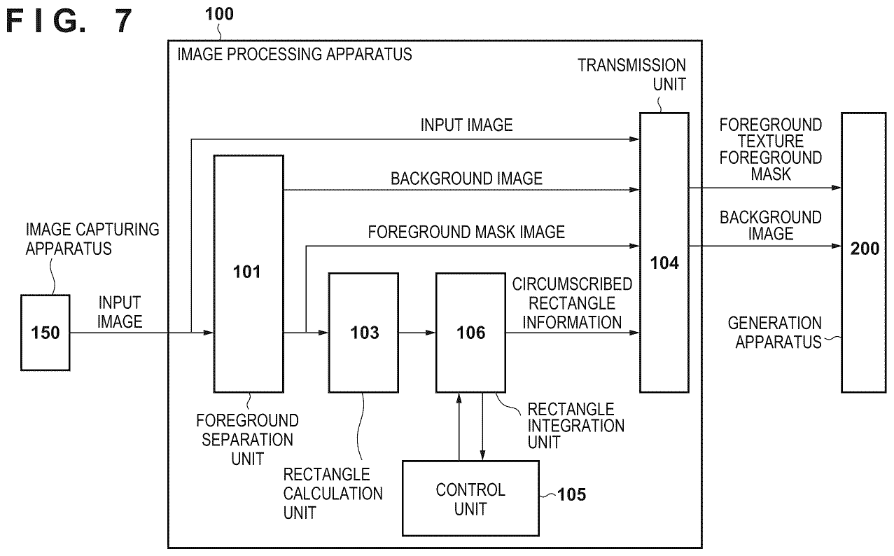

The image processing apparatus 100 according to the present embodiment will be described, referring to FIG. 7. The image processing apparatus 100 has a rectangle integration unit 106, in addition to the foreground separation unit 101, the rectangle calculation unit 103, the transmission unit 104, and the control unit 105. In the following, only the difference from the first embodiment will be described.

In the present embodiment, the rectangle calculation unit 103 divides the foreground region into a plurality of regions. For example, the rectangle calculation unit 103 can calculate a plurality of rectangles that are part of the circumscribed rectangle and adjacent to each other, as a preliminary process for calculating the circumscribed rectangle of the foreground region. A set of the plurality of rectangles may include a single foreground region. Each of the plurality of rectangles calculated by the rectangle calculation unit 103 in the present embodiment is a rectangle circumscribing each of the regions acquired by dividing the foreground region. Each rectangle can be searched and calculated according to raster scan.

The rectangle integration unit 106 defines a single divided region by integrating a group of adjacent regions that are some of the plurality of regions. In the present embodiment, the rectangle integration unit 106 sequentially integrates adjacent rectangles. Integration refers to calculating a circumscribed rectangle for two adjacent rectangles. In other words, the rectangle integration unit 106 can calculate a circumscribed rectangle of the rectangle group as the result of integrating the rectangle group. As such, the rectangle integration unit 106 can calculate the circumscribed rectangle for one divided region by the process of integrated a group of adjacent rectangles, which are a part of the rectangles circumscribing a plurality of regions.

Here, the rectangle integration unit 106 can define the divided regions so that the area of a circumscribed rectangle for a single divided region is equal to or larger than a threshold value. For example, the rectangle integration unit 106 can determine whether or not to further integrate a rectangle with the rectangle group, in accordance with the area of the circumscribed rectangle calculated as the integration result of the rectangle group. Specifically, the rectangle integration unit 106 can calculate the area of the circumscribed rectangle calculated as the integration result and compare the area with a threshold value. The rectangle integration unit 106 then can determine, based on the comparison result, whether or not to further integrate a rectangle with the circumscribed rectangle calculated as the integration result.

Here, when using hardware to calculate a circumscribed rectangle of a foreground region having a complicated shape according to the raster scan method, it is not easy to calculate the circumscribed rectangle in a single iteration (within a period of a single frame) due to restrictions on circuit scale and processing time. In the present embodiment, therefore, a circumscribed rectangle is calculated for each divided region by calculating, by the rectangle calculation unit 103, a plurality of rectangles as a preliminary process and subsequently integrating, by the rectangle integration unit 106, the rectangles.

The control unit 105 controls the threshold value of area to be referred to by the rectangle integration unit 106. The control unit 105 can control the threshold value according to the total area of the circumscribed rectangles calculated according to the threshold value. In the present embodiment, the control unit 105 controls the threshold value in accordance with the transmission rate of the foreground image. In addition, the control unit 105 can control the threshold value in accordance with the communication speed of the image processing apparatus 100.

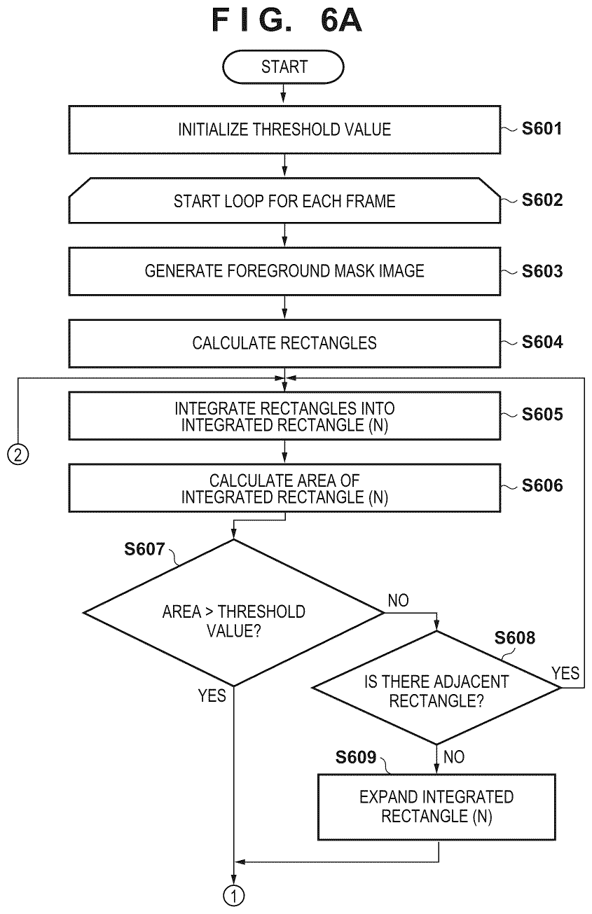

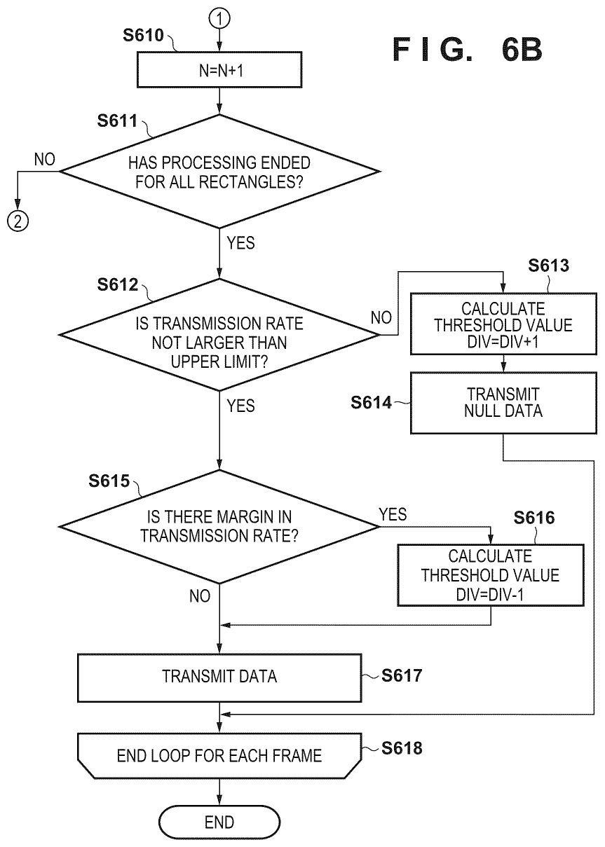

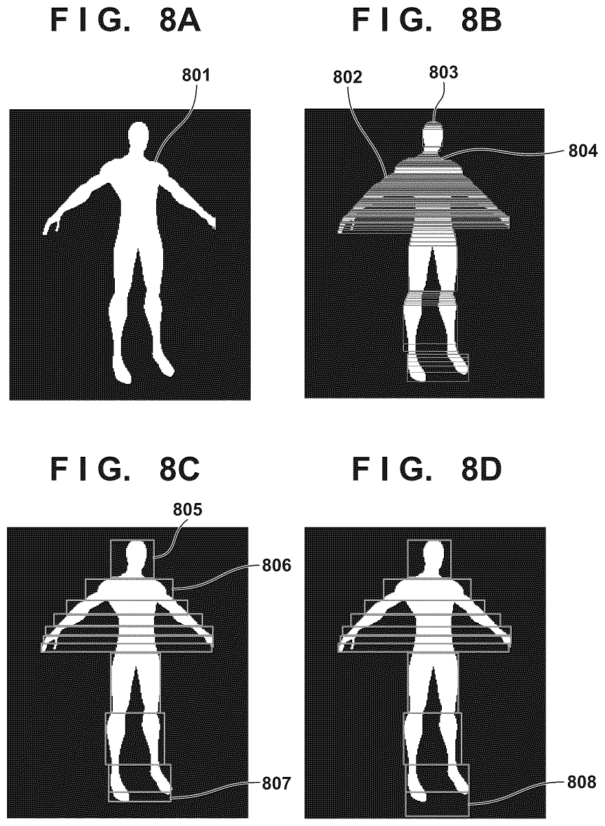

In the following, there will be described a process to be performed by the image processing apparatus 100 of the present embodiment, referring to FIGS. 6A to 6B and FIGS. 8A to 8D. FIGS. 6A to 6B are flowcharts of a process to be performed by the image processing apparatus 100 of the present embodiment.

At S601, the control unit 105 initializes both the threshold value of area to be referred to at S607 and the number of divisions (DIV) described below. In the present example, the threshold value of area is initialized to an “approximate area of the circumscribed rectangle of the foreground region”. In addition, the number of divisions is initialized to “1”. The approximate area of the circumscribed rectangle can be determined by the user in accordance with the angle of view of the camera and the size of the object to be shot. However, the initial values are not limited to those described above. For example, the number of divisions may be initialized to enable division.

Steps S602 to S603 are performed similarly to steps S401 to S402. FIG. 8A illustrates an example of a foreground mask image generated at S603. FIG. 8A illustrates a foreground region 801.

At S604, the rectangle calculation unit 103 calculates information of a plurality of adjacent rectangles that are a part of the circumscribed rectangle, as a preliminary process for calculating the circumscribed rectangle of the foreground region. As described above, the rectangle calculation unit 103 can search and calculate each rectangle in accordance with raster scan. FIG. 8B illustrates a plurality of rectangles 802 thus calculated. In addition, each of the rectangles is labeled with a number for identifying the rectangle in the order of calculation. In addition, numbers indicating adjacent rectangles are recorded for respective rectangles as information indicating inter-rectangle adjacency relationship. The rectangle calculation unit 103 can calculate the information indicating vertex coordinates, numbers, and adjacency relationship of respective rectangles as information about respective rectangles. In the present example, a plurality of rectangles adjacent to each other in the vertical direction (or horizontal direction) are calculated for a single foreground region.

Here, the rectangle calculation unit 103 can detect a rectangle including continuous pixels in the foreground region for each row of the foreground mask image. In addition, when a rectangle located in an upper row is adjacent to a rectangle located in a lower adjacent row, and expanding the rectangle located in the upper row downward causes the rectangle located in the lower adjacent row to be included in the expanded rectangle, the rectangle located in the upper row and the rectangle located in the lower adjacent row are integrated. As such, the plurality of rectangles 802 illustrated in FIG. 8B can be calculated.

At S605, the rectangle integration unit 106 integrates the rectangles calculated at S604. The rectangle integration unit 106 can integrate the selected two rectangles. The rectangle integration unit 106 can generate vertex coordinates of the circumscribed rectangle of the two rectangles, numbers of the two rectangles, and information indicating the adjacency relationship between the two rectangles as information of the rectangle acquired by integration.

At S605, the rectangle integration unit 106 can integrate an integrated rectangle (N) and a rectangle adjacent to the integrated rectangle, in accordance with the adjacent information. The integrated rectangle refers to a rectangle acquired by the integration process performed through the loop from S605 to S608. In addition, the integrated rectangle (N) refers to a rectangle to which a rectangle is to be integrated in the (N+1)-th iteration of the loop from S605 to S611. In the loop from S605 to S608, rectangles adjacent to the integrated rectangle (N) are integrated one by one. However, the integrated rectangle (N) does not exist yet in the first iteration of the loop from S605 to S608. Therefore, the integrated rectangle (N) is treated as a NULL value in the first iteration of the loop.

For example, at S605 in the first iteration of the loop from S605 to S608 when N=0, the NULL value and the rectangle 803 bearing the smallest number illustrated in FIG. 8B are integrated, such that the integrated rectangle (0) is the rectangle 803. At and after the second iteration of the loop, the rectangles immediately below and adjacent to the rectangle 803 are integrated one after another. Finally, a rectangle 805 illustrated in FIG. 8C is acquired as a completed integrated rectangle (0).

In addition, at S605 in the first iteration of the loop from S605 to S608 when N=1, the NULL value and a yet-to-be-integrated rectangle 804 bearing the smallest number are integrated, such that the integrated rectangle (1) is the rectangle 804. At and after the second iteration of the loop, the rectangles immediately below and adjacent to the rectangle 804 are integrated one after another. Finally, a rectangle 806 illustrated in FIG. 8C is acquired as a completed integrated rectangle (1).

At S606, the rectangle integration unit 106 calculates the area of the integrated rectangle (N) acquired by integration at S605. The rectangle integration unit 106 can calculate the area from the vertex coordinates.

At S607, the rectangle integration unit 106 compares the area calculated at S606 with the threshold value of area that has been set by the control unit 105. When the area is smaller than the threshold value, the process proceeds to S608. When the area is larger than or equal to the threshold value, generation of the integrated rectangle (N) is completed. In other words, vertex coordinates of the integrated rectangle (N) are established. Subsequently, the process proceeds to S610.

At S608, the rectangle integration unit 106 determines presence or absence of a rectangle that is adjacent to the integrated rectangle (N) and is to be integrated next, referring to the adjacent information about the integrated rectangle (N) acquired at S605. When there exists an adjacent rectangle, the process returns to S605. The rectangle adjacent to the integrated rectangle (N) is then integrated into the integrated rectangle (N). Absence of any adjacent rectangle means that the last of the plurality of rectangles adjacent to each other has been integrated and also the area of the integrated rectangle (N) falls below the threshold value. In such a case, the integrated rectangle (N) is determined to be a fractional rectangle. FIG. 8C illustrates such a fractional rectangle 807. The process then proceeds to S609.

At S609, the rectangle integration unit 106 expands the integrated rectangle (N). In the present example, the area of the integrated rectangle (N) falls below the threshold value. As described above, the rectangle integration unit 106 can expand the circumscribed rectangle when the area of the circumscribed rectangle for a divided region adjacent to another divided region falls below the threshold value. For example, the rectangle integration unit 106 can shift the vertex coordinates of the integrated rectangle (N). Specifically, the rectangle integration unit 106 can increase the Y-coordinates of the lower left and lower right vertex coordinates of the integrated rectangle (N) so that the area of the integrated rectangle (N) becomes equal to the threshold value of area that has been set by the control unit 105. FIG. 8D illustrates a rectangle 808 expanded as such. Here, the rectangle integration unit 106 may shift X-coordinates of the vertices. Here, when the coordinates after expansion exceed the maximum value of the coordinates in the vertical or horizontal direction, the coordinates after expansion may be clipped to the coordinates of the maximum value.

At S610, the rectangle integration unit 106 increments N. At S611, the rectangle integration unit 106 determines whether or not the integration process has been completed for all the rectangles. For example, the rectangle integration unit 106 determines whether or not the number of the last rectangle integrated at S605 is equal to the number of the last rectangle labeled at S604. When the numbers match, the rectangle integration unit 106 determines that the integration process has been completed for all of the rectangles. The process then proceeds to S612. When the numbers do not match, the rectangle integration unit 106 determines that there remains a rectangle that is not to be integrated. The process then returns to S605. Subsequently, at the next iteration of the loop from S605 to S611, the integrated rectangle (N) to be integrated next is generated.

Each integrated rectangle thus acquired illustrated in FIG. 8C represents a circumscribed rectangle for each of the divided regions acquired by dividing a single foreground region. Also in FIG. 8D, each of the integrated rectangles other than the rectangle 808 acquired at least at the end represents a circumscribed rectangle for each of the divided regions acquired by dividing a single foreground region. Here, in the present example, the rectangle 807 is a circumscribed rectangle for a part of a single foreground region, and therefore it is unlikely to have been derived from noise. In order to prevent the image data of the rectangle 807 from being excluded from transmission, the rectangle 807 has been expanded to the rectangle 808. However, it is not essential to expand a circumscribed rectangle that is smaller than the threshold value.

At S612, the control unit 105 compares the transmission rate of the foreground image and the upper limit value, similarly to S502. The transmission rate in the present embodiment indicates the ratio of the total sum of the areas of the integrated rectangles relative to the area of input image of a single frame. When the transmission rate is equal to or lower than the upper limit value, the process proceeds to S615. When, alternatively, the transmission rate is higher than the upper limit value, the process proceeds to S613.

At S613, the control unit 105 updates the threshold value of area to be smaller. For example, the control unit 105 can increment the number of divisions (DIV). The control unit 105 then calculates the threshold value according to Formula (5). In Formula (5), TH represents the threshold value of area. In addition, THini represents the initial value of area that has been set at S601. Similarly to the modification of the first embodiment, an upper limit may be set for the number of divisions (DIV).

$$TH = THini / DIV \qquad Formula ( 5 )$$

S614 is performed similarly to S504.

At S615, the control unit 105 compares the difference between the transmission rate calculated at S612 and the upper limit value with a margin value, similarly to S505. When the difference value is larger than or equal to the margin value, the process proceeds to S616. When the difference value is smaller than the margin value, the process proceeds to S617.

At S616, the control unit 105 updates the threshold value of area to be larger. For example, the control unit 105 can first decrement the number of divisions (DIV). The control unit 105 then can calculate the threshold value of area based on the aforementioned formula (5).

Steps S617 to S618 are performed similarly to steps S406 to S407. In the present embodiment, transmission targets at S406 of the foreground image and the foreground mask image are limited to those within each integrated rectangle. When it is determined to continue the process at S407, the process returns to S601.

Also in the present embodiment as described above, a circumscribed rectangle is calculated for each of a plurality of divided regions acquired by dividing a single foreground region. Subsequently, data of the input image within the circumscribed rectangle is transmitted to the outside. The transmission load can therefore be reduced. In particular, the circumscribed rectangle is calculated so as to have a certain area, according to the present embodiment. The foregoing prevents calculating an extremely small circumscribed rectangle that may be determined to have been derived from noise.

### OTHER EMBODIMENTS

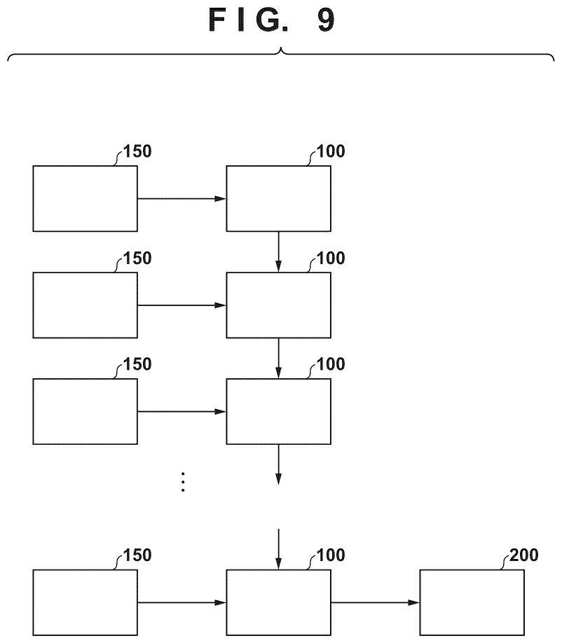

Each of the image processing apparatuses 100 at the rear stage of the plurality of image capturing apparatuses 150 may be connected to the generation apparatus 200, or the plurality of image processing apparatuses 100 may be cascade-connected. FIG. 9 illustrates a configuration example of an image processing system in which a plurality of image processing apparatuses 100 are cascade-connected. The image processing system may further have a plurality of image capturing apparatuses 150 and a generation apparatus 200. In other words, in FIG. 9, data output from the transmission unit 104 of the image processing apparatus 100 located upstream are input to the transmission unit 104 of the image processing apparatus 100 located downstream, and transmitted to the image processing apparatus 100 located further downstream thereof. In other words, data processed by the image processing apparatus 100 located upstream are received by the image processing apparatus 100 located downstream. In addition, the image processing apparatus 100 located downstream transmits the data processed by itself and the data received from the image processing apparatus 100 located upstream of the image processing apparatus 100 located further downstream, and transmits the data to the generation apparatus 200 via the latter image processing apparatus 100. Accordingly, data processed by each image processing apparatus 100 is transmitted to the generation apparatus 200 in accordance with the cascade connection. In such a configuration of the cascade connection, increased data amount may accelerate shortage of transmission bandwidth and therefore application of the aforementioned embodiment suppresses shortage of transmission bandwidth. Here, the plurality of image processing apparatuses 100 used in the present system may all be connected by a single cascade connection, or the plurality of image processing apparatuses 100 may be classified into several groups, with each group being cascade-connected.

As described above, the image processing system according to an embodiment can have a plurality of image processing apparatuses 100 and a generation apparatus 200. The plurality of image processing apparatuses 100 can have a first image processing apparatus and a second image processing apparatus. Here, the second image processing apparatus can receive data to be processed by the first image processing apparatus. For example, the first image processing apparatus can calculate, as described above, a circumscribed rectangle of the foreground region from the input image captured by the image capturing apparatus 150 connected to the first image processing apparatus. The first image processing apparatus then can transmit data of the input image within the calculated circumscribed rectangle to the second image processing apparatus according to the aforementioned method. In addition, the second image processing apparatus can transmit, to the generation apparatus 200, data received from the first image processing apparatus and data to be processed by the second image processing apparatus. For example, also the second image processing apparatus can calculate the circumscribed rectangle of the foreground region as described above from the input image captured by the image capturing apparatus 150 connected to the second image processing apparatus. The second image processing apparatus then can transmit data of the input image within the calculated circumscribed rectangle to the generation apparatus 200 together with the data received from the first image processing apparatus according to the aforementioned method. On this occasion, the second image processing apparatus can transmit data to the generation apparatus 200 via another image processing apparatus 100.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-140269, filed Aug. 30, 2023, which is hereby incorporated by reference herein in its entirety.

What is claimed is:

1. An image processing apparatus comprising:
one or more memories storing instructions; and
one or more processors that execute the instructions to:
detect a foreground region from an input image;
obtain a plurality of divided regions by dividing the foreground region;
determine a circumscribed rectangle for one of the plurality of divided regions; and
transmit data of the input image corresponding to the circumscribed rectangle.

2. The image processing apparatus according to claim 1, wherein the one or more processors execute the instructions to generate a foreground mask image representing the foreground region.

3. The image processing apparatus according to claim 2, wherein
the plurality of divided regions are obtained by dividing the foreground mask image, and
the circumscribed rectangle is determined based on the divided foreground mask image.

4. The image processing apparatus according to claim 1, wherein the plurality of divided regions are obtained by dividing the foreground region in a horizontal direction, a vertical direction, or into a grid-like pattern.

5. The image processing apparatus according to claim 1, wherein the plurality of divided regions are obtained by dividing the foreground region in accordance with a predetermined spacing.

6. The image processing apparatus according to claim 5, wherein the one or more processors execute the instructions to determine the predetermined spacing.

7. The image processing apparatus according to claim 6, wherein the predetermined spacing is determined based on a total area of the circumscribed rectangles.

8. The image processing apparatus according to claim 1, wherein
the plurality of divided regions is obtained by dividing the foreground region into a plurality of regions and by integrating a group of adjacent regions that are a part of the plurality of regions.

9. The image processing apparatus according to claim 8, wherein an area of a circumscribed rectangle for one of the plurality of the divided regions is equal to or larger than a threshold value.

10. The image processing apparatus according to claim 9, wherein the one or more processors execute the instructions to determine the threshold value.

11. The image processing apparatus according to claim 10, wherein the threshold value is determined based on a total area of the circumscribed rectangle.

12. The image processing apparatus according to claim 1, wherein the one or more processors execute the instructions to determine a plurality of rectangles, each of the plurality of rectangles circumscribe a plurality of regions obtained by dividing the foreground region, and the circumscribed rectangle is determined by integrating a rectangle group of adjacent rectangles which are a part of the plurality of rectangles.

13. The image processing apparatus according to claim 12, wherein the one or more processors execute the instructions to determine whether or not to integrate another rectangle into the rectangle group, in accordance with the area of the calculated circumscribed rectangle.

14. The image processing apparatus according to claim 1, wherein, in a case where an area of a circumscribed rectangle of a divided region adjacent to another divided region is smaller than a threshold value, the circumscribed rectangle is expanded.

15. The image processing apparatus according to claim 2, wherein the one or more processors execute the instructions to transmit data of the foreground mask image corresponding to the circumscribed rectangle.

16. The image processing apparatus according to claim 1, wherein
data of the input image which does not correspond to the circumscribed rectangle is not transmitted.

17. The image processing apparatus according to claim 16, wherein the one or more processors execute the instructions to transmit data of a background region in the input image.

18. The image processing apparatus according to claim 1, wherein, in a case where an area of the circumscribed rectangle is smaller than a threshold value, data of the input image corresponding to the circumscribed rectangle is not transmitted.

19. An image processing method comprising:
detecting a foreground region from an input image;
obtaining a plurality of divided regions by dividing the foreground region;
determining a circumscribed rectangle for one of the plurality of divided regions; and
transmitting data of the input image corresponding to the circumscribed rectangle.

20. An image processing system comprising:
an image processing apparatus configured to:
detect a foreground region from an input image;
obtain a plurality of divided regions by dividing the foreground region;
determine a circumscribed rectangle for one of the plurality of divided regions; and
transmit data of the input image corresponding to the circumscribed rectangle, and
a generation apparatus configured to generate a three dimensional data based on the data transmitted from the image processing apparatus.
